(19) United States
(12) Patent Application Publication
(10) Pub. No.: US 2012/0285940 A1
(43) Pub. Date: Nov. 15, 2012

(54) ERGONOMIC PROTECTIVE SHELL FOR PROTECTING HANDHELD TOOLS

(76) Inventors: Darren R. Phill, Calgary (CA); Mark Backer, Balzak (CA); Robert Desaulniers, Calgary (CA)

(21) Appl. No.: 13/451,179

(22) Filed: Apr. 19, 2012

Related U.S. Application Data
(60) Provisional application No. 61/477,118, filed on Apr. 19, 2011.

(51) Int. Cl. B25G 1/10; B23K 9/32

(52) U.S. Cl. 219/138; 81/489

(57) ABSTRACT

There is disclosed an ergonomic protective shell for protecting handheld tools. The ergonomic protective shell and method disclosed herein is particularly suited for protecting handheld welding tools in cold weather. In a preferred embodiment, the protective shell comprises a substantially elongate tool handle shell for receiving a handle region of a handheld welding tool. A protective head shell may also cover a head portion of the handheld welding tool, providing a custom shaped head shell piece fitting the contours of the head portion of the handheld welding tool. The protective shell may be made of a material which may remain resilient and flexible in cold, is heat resistant, or is otherwise reinforced to absorb impacts in cold weather without breakage.

### CROSS REFERENCE TO RELATED APPLICATIONS

The present application claims the benefit of U.S. Provisional Application No. 61/477,118, filed on 19 Apr. 2011, the entirety of which is incorporated herein by reference.

### FIELD

The present disclosure relates to an ergonomic protective shell for protecting handheld tools.

### BACKGROUND

Handheld tools are often used in harsh environments, such as the outdoors during cold weather. In cold weather conditions, low temperatures may cause handheld tools to become cold and brittle, making the tools easier to chip and break when handled roughly. To protect such tools, attempts have been made at designing protective shells. However, prior designs for protective shells for handheld tools have suffered from similar problems, where hard plastics meant to protect the tools also become brittle in cold weather, and the protective shells themselves become subject to chipping or breaking. In addition, prior protective shell designs may not take into account ergonomic considerations.

What is needed is an improved protective shell for protecting handheld tools which overcomes at least some of the drawbacks and limitations as described above.

### SUMMARY

The present disclosure relates to an ergonomic protective shell for protecting handheld tools. The ergonomic protective shell disclosed herein is particularly well suited for protecting handheld welding tools, but may also be used as protective shells for other types of handheld tools. In a preferred embodiment, the protective shell comprises a substantially elongate tool handle shell for receiving a handle region of a handheld welding tool. A protective head shell may also cover a head portion of the handheld welding tool, providing a custom shaped head shell piece fitting the contours of the head portion of the handheld welding tool. In an embodiment, the protective shell is made of a material which remains resilient and flexible in cold weather, is heat resistant, and absorbs impacts without breakage.

In a more preferred embodiment, the tool handle shell includes a neck portion, an enlarged shoulder portion, and a handle portion which narrows again. The handle portion may include a plurality of small bumps or protuberances for allowing a better grip of the handheld welding tool in use. The tool handle shell is also adaptable to other types of handheld tools requiring a secure, ergonomic grip.

The ergonomic protective shell allows the handheld welding tool or other type of handheld tool to be held more comfortably, and also allows the handheld welding tool or other type of handheld tool to be better protected during use.

In another aspect, there is provided a tool handle shell, comprising: a generally elongate body adapted to receive a handle region of a handheld tool, the elongate body having a neck portion, an enlarged shoulder portion, and a handle portion; whereby the enlarged shoulder portion acts to provide a grasping point such that holding the handheld tool is more comfortable to hold for longer periods of time. The elongate body comprises a material that is resilient in cold weather, is heat resistant, and absorbs substantial impacts without breakage.

In another aspect, there is provided a handle shell for a handheld welding tool, comprising: a generally elongate body adapted to receive a handle region of the handheld welding tool, the elongate body having a neck portion, an enlarged shoulder portion, and a handle portion; wherein the elongate body comprises a material that is resilient in cold weather, is heat resistant, and absorbs substantial impacts without breakage. In an embodiment, the elongate body comprises a glass reinforced nylon or glass reinforced polyurethane material.

In another aspect, there is provided a head shell for a handheld welding tool, comprising: a face portion defining an opening for accommodating an arc welding electrode holder of the handheld welding tool extending therethrough; a base portion defining an opening for receiving a neck portion of the arc welding electrode holder tool extending therethrough; wherein the tool head shell comprises a material that is resiliently flexible in cold weather, is heat resistant, and absorbs substantial impacts without breakage.

Other aspects and features of the embodiments herein will become apparent to those ordinarily skilled in the art upon review of the following description of specific embodiments in conjunction with the accompanying figures.

### BRIEF DESCRIPTION OF THE DRAWINGS

FIG. 1A. shows a front view of a tool head shell in accordance with an embodiment;

FIG. 1B shows a rear view of the tool head shell of FIG. 1A;

FIG. 1C shows a side view of the tool head shell of FIG. 1A;

FIG. 1D shows a top view of the tool head shell of FIG. 1A;

FIG. 1E shows a bottom view of the tool head shell of FIG. 1A;

FIG. 1F shows another side view of the tool head shell of FIG. 1A;

FIG. 1G shows a perspective view of the tool head shell of FIG. 1A;

FIG. 2A shows a perspective view of a tool handle shell in accordance with an embodiment;

FIG. 2B shows a front view of the tool handle shell of FIG. 2A;

FIG. 2C shows a side view of the tool handle shell of FIG. 2A, and further includes a bottom end view;

FIG. 2D shows a partial cut-out view of the tool handle shell of FIG. 2A;

FIG. 2E shows a top end view of the tool handle shell of FIG. 2D;

FIG. 2F shows a bottom end view of the tool handle shell of FIG. 2D; and

FIG. 2G shows an enlarged front view of the tool handle shell of FIG. 2A.

### DETAILED DESCRIPTION

As noted above, the present disclosure relates to an ergonomic protective shell for protecting handheld tools. More particularly, the embodiments disclosed herein are particularly well suited for protecting handheld welding tools. Illustrative embodiments of the ergonomic protective shells will now be described with reference to the accompanying drawings.

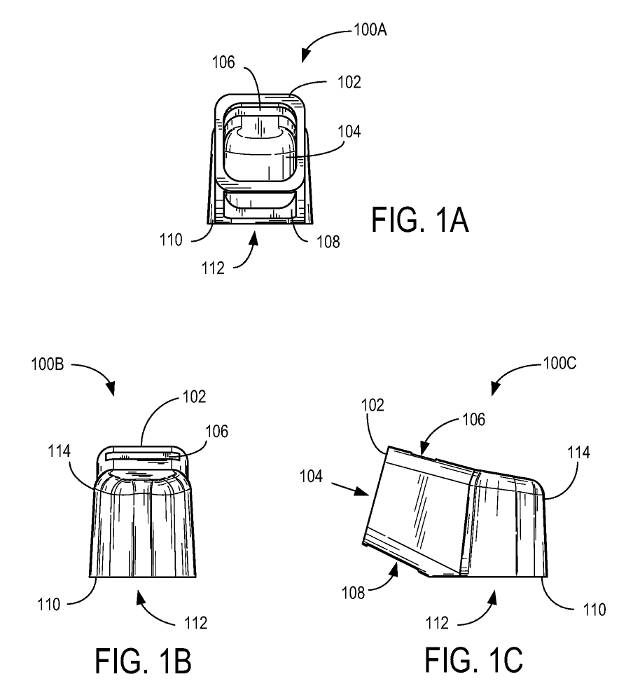

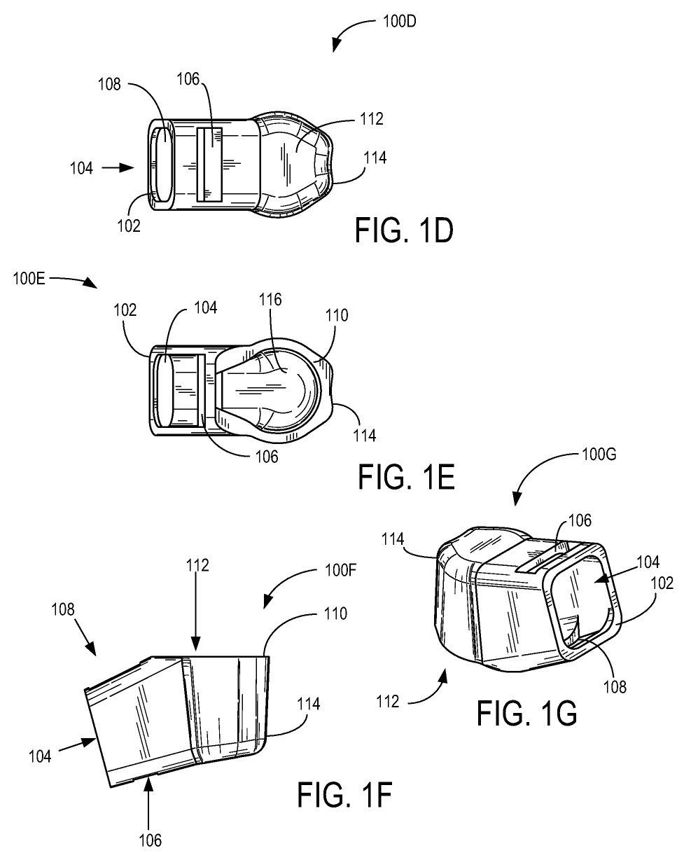

Referring to FIG. 1A, shown is a front view 100A of a tool head shell in accordance with an embodiment. Tool head shell 100A includes a face portion 102 defining an opening 104 for accommodating an arc welding electrode holder (not shown) from which a welding rod will extend. Tool head shell 100A also includes an opening 106 at a top surface of tool head shell 100A for allowing access to a top portion of the arc welding electrode holder as may be required. Tool head shell 100A may further include another opening 108 at a chin portion of tool head shell 100A for allowing access to the chin portion of the arc welding electrode holder tip, or to allow for a protuberance from the arc welding electrode holder tip to extend through opening 108. Tool head shell 100A further includes a base 110 defining an opening 112 at a bottom portion of head shell 100A, for receiving the neck portion of an arc welding electrode holder. By providing tool head shell 100A as a separate piece, tool head shell 100A allows the head portion of an arc welding electrode holder to swivel as may be required.

Now referring to FIG. 1B, shown is a rear view 100B of the tool head shell of FIG. 1A. Tool head shell 100B shows more clearly opening 106 provided at the top surface of tool head shell 100A. In addition, tool head shell 100B includes a back portion 114 which provides cover for the back portion of the head of an arc welding electrode holder tool.

Now referring to FIG. 1C, shown is a side view 100C of the tool head shell of FIG. 1A. As shown, tool head shell 100C provides another view of face portion 102 defining opening 104. Tool head shell 100C also shows a side view of opening 106 provided at the top of tool head shell 100C, and a side view of opening 108 provided hear the chin portion of tool head shell 100C.

Shown in FIG. 1D is a top view 100D of the tool head shell of FIG. 1A. As shown, tool head shell 100D shows another view of opening 108, and opening 112. Face portion 102 and back portion 114 are also identified to provide points of reference. Face portion 102 defines opening 104 as earlier described.

Now referring to FIG. 1E, shown is a bottom view 100E of the tool head shell of FIG. 1D. From this view, opening 104 and opening 106 are shown more clearly through opening 108 and opening 112. Face portion 102 and back portion 114 are identified to provide points of reference. An inner surface 116 of tool head shell 100E is also seen through opening 112.

FIG. 1F shows another side view 100F of the tool head shell of FIG. 1A. Tool head shell 100F shows the positions of the various openings in tool head shell 100F, including opening 104, opening 106, opening 108 and opening 112.

Now referring to FIG. 1G, shown is a perspective view 100G of the tool head shell of FIG. 1A with corresponding opening 104, opening 106, opening 108 and opening 112.

In a preferred embodiment, the tool head shell of FIGS. 1A-1G is made of a flexible, resilient material which remains flexible and resilient in cold temperatures, such as may be found outdoors on a cold winter day. For example, rather than a hard plastic material, a flexible rubber material or the like may be used instead. In addition to remaining flexible and resilient in cold temperatures, the tool head shell of FIGS. 1A-1G needs to have sufficient resistance to high temperatures that may be present near the tip of the welding tool. Thus, the material selected for the tool head shell should be capable of withstanding both cold and hot temperatures. As an illustrative example, a low hardness, thermoplastic elastomer may be used which can be processed by injection molding. The thermoplastic elastomer may by polypropylene based, and should be resistance to high temperature but remain flexible and resilient in cold weather. Other suitable materials include heat resistant silicon or polyurethane, which provide high flexibility and resilience.

In use, the tool head shell of FIGS. 1A-1G is fitted over the head portion of an arc welding electrode holder, so that the arc welding electrode holder head is substantially protected from all angles. The tool head shell of FIGS. 1A-1G is also configured to allow the head of a welding tool to swivel as may be required.

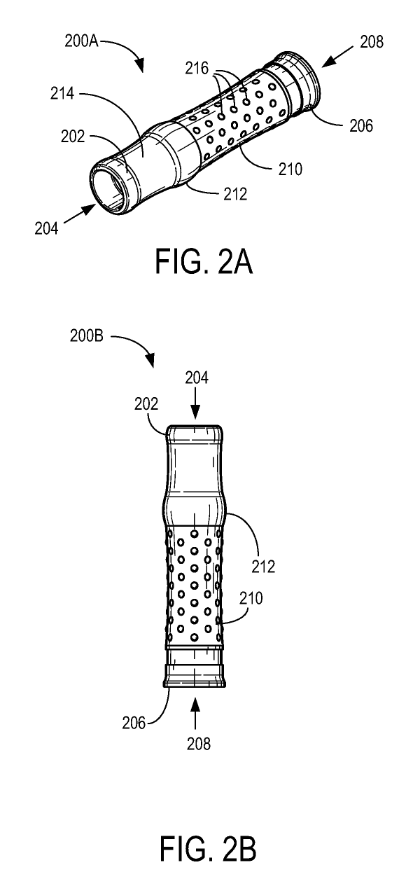

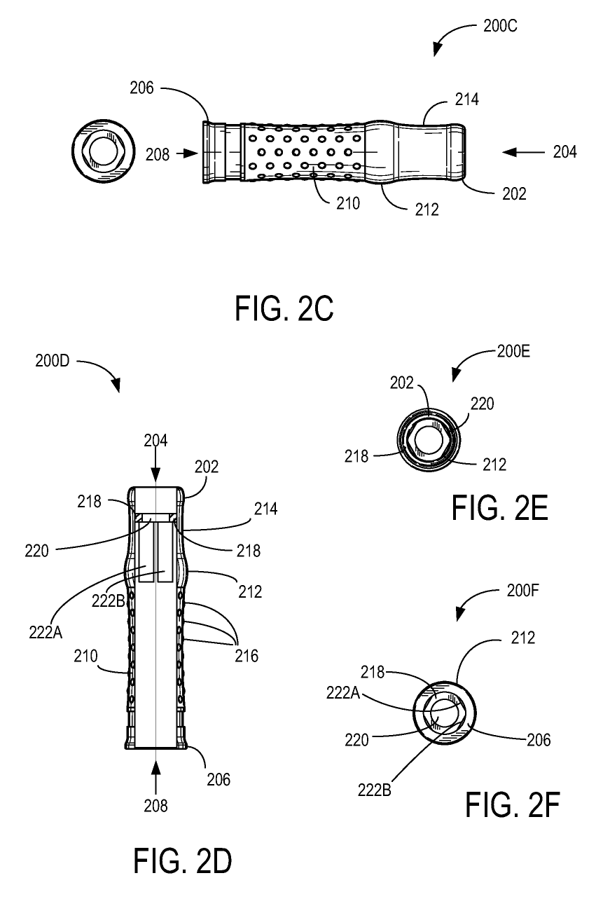

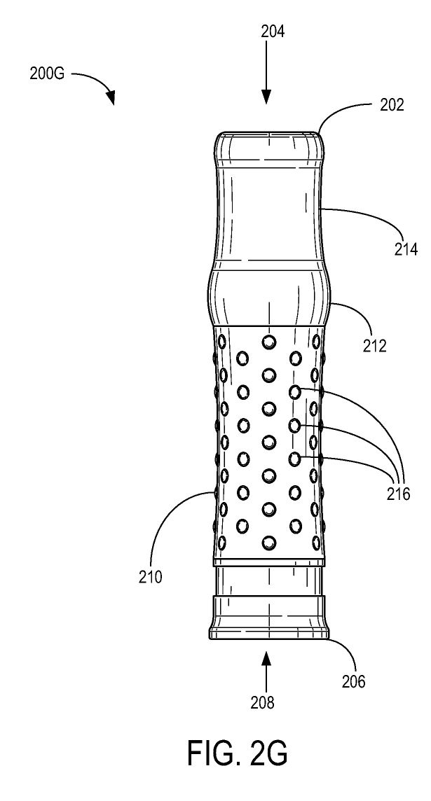

In addition to a tool head shell as shown and described above, a tool handle shell may also be used to protect the handle region of a welding tool. An illustrative embodiment of a tool handle shell will now be described with reference to FIGS. 2A-2G.

Now referring to FIG. 2A, shown is a perspective view 200A of a tool handle shell in accordance with an embodiment. As shown, tool handle shell 200A includes a top portion 202 defining a top opening 204, and a bottom or base portion 206 defining a base opening 208. Tool handle shell 200A further includes a handle portion 210, an enlarged shoulder portion 212, and a narrowed neck portion 214. As shown in this illustrative example, handle portion 210 may include a plurality of bumps or protuberances 216 which may allow better grip when the welding tool (not shown) is held.

Advantageously, the narrowed neck portion 214 and enlarged shoulder portion 212 act to provide a grasping point such that holding the welding tool for longer periods of time is comfortable for the operator. In combination with the plurality of bumps or protuberances 216, the enlarged shoulder portion 212 and narrowed neck portion 214 act together to allow the tool handle shell to be grasped comfortably without slippage, even when the user is wearing protective gloves when outside in cold weather.

Referring to FIG. 2B, shown is a front view 200B of the tool handle shell of FIG. 2A. As shown, tool handle shell 200B includes another view of the top portion 202 defining top opening 204, an enlarged shoulder portion 212, a handle portion 210, and a base portion 206 defining base opening 208.

FIG. 2C shows a side view 200C of the tool handle shell of FIG. 2B, and further includes a bottom end view of one of the ends of the tool handle shell. As shown, FIG. 2C includes illustrative dimensions for various features of the tool handle shell of FIG. 2B.

Now referring to FIG. 2D, shown is a partial cut-out view 200D of the tool handle shell of FIG. 2A. As shown, tool handle shell 200D includes top portion 202 defining top opening 204, and base portion 206 defining a base opening 208. This partial cut out view also shows handle portion 210 including a plurality of bumps or protuberances 216, enlarged shoulder portion 212, and narrowed neck portion 214.

In addition, this partial cut-out view shows flange 218 defining a narrower throat opening 220. In use, flange 218 acts as a stop for a welding tool handle inserted into tool handle shell 200D, allowing a narrower portion of the welding tool handle to extend through and connect to a head portion of the welding tool, covered by the tool head shell as earlier described with reference to FIGS. 1A-1G.

Still referring to FIG. 2D, below the throat opening 220 are a number of surfaces 222A, 222B extending from the inner wall of tool handle shell 200D. In use, these surfaces 222A, 222B are used to receive a similarly shaped feature of the handle region of the welding tool so that tool handle shell 200D is held in position and is not easily removed. For this purpose, tool handle shell 200D should be sufficiently flexible and resilient to allow for some flexibility and resilience in accommodating a welding tool inside.

Now referring to FIG. 2E, shown is a top end view 200E of the tool handle shell of FIG. 2D. This top end view more clearly shows flange 218 defining a narrower throat opening 220.

Referring to FIG. 2F, shown is a bottom end view 200F of the tool handle shell of FIG. 2D. This bottom end view 200F shows more clearly surfaces 222A, 222B extending from the inner wall of tool handle shell 200D to receive a similarly shaped feature of a welding tool inserted into tool handle shell 200D.

Finally, FIG. 2G shows an enlarged front view 200G of the tool handle shell of FIG. 2A, including the previously described features of the top portion 202, top opening 204, narrowed neck portion 214, enlarged shoulder portion 212, bumps or protuberances 216, handle portion 210, base portion 206, and base opening 208.

Preferably, the tool handle shell of FIGS. 2A-2G is made of a strong material which is resistant to cold and heat. As an illustrative example, the tool handle shell may be made of a glass reinforced nylon or glass reinforced polyurethane material suitable for injection moulding. The cold weather strength and long term temperature resistance of this material makes it suitable for use for the tool handle shell.

In addition, a glass reinforced nylon or glass reinforced polyurethane material is relatively light weight, so that the tool handle shell does not add a significant amount of weight when holding a handheld tool such as a welding tool.

Thus, in an aspect, there is provided a tool handle shell, comprising: a generally elongate body adapted to receive a handle region of a handheld tool, the elongate body having a neck portion, an enlarged shoulder portion, and a handle portion; whereby the enlarged shoulder portion acts to provide a grasping point such that holding the handheld tool is more comfortable to hold for longer periods of time.

In an embodiment, the elongate body comprises a material that is resilient in cold weather, is heat resistant, and absorbs substantial impacts without breakage.

In another embodiment, the elongate body comprises a glass reinforced nylon or glass reinforced polyurethane material.

In another embodiment, the handle portion includes a plurality of protuberances on its surface for providing a better grip of the handheld tool in use.

In another embodiment, the elongate body further includes a flange defining a narrowed throat opening, the flange acting as a stop for the handle region of the handheld tool inserted into the tool handle shell.

In another embodiment, the elongate body further includes a plurality of surfaces extending from an inner wall of elongate body, the surfaces adapted to receive a correspondingly shaped feature of the handle region of the handheld tool, such that the handheld tool is held in position within the elongate body.

In another embodiment, the elongate body further includes a flange defining a narrowed throat opening in the neck portion of the elongate body, and a plurality of surfaces extending from an inner wall of elongate body below the flange, whereby the flange acts as a stop for the handle region of the handheld tool inserted into the tool handle shell, and the surfaces extending from an inner wall of elongate body are adapted to receive a correspondingly shaped feature of the handle region of the handheld tool, such that the handle region of the handheld tool is securely held in position within the elongate body.

In another embodiment, the handheld tool is a handheld welding tool, and the elongate body is adapted to receive a handle region of the handheld welding tool.

In another aspect, there is provided a tool handle shell for a handheld welding tool, comprising: a generally elongate body adapted to receive a handle region of the handheld welding tool, the elongate body having a neck portion, an enlarged shoulder portion, and a handle portion; wherein the elongate body comprises a material that is resilient in cold weather, is heat resistant, and absorbs substantial impacts without breakage.

In an embodiment, the elongate body comprises a glass reinforced nylon or glass reinforced polyurethane material.

In another embodiment, the handle portion includes a plurality of protuberances on its surface for providing a better grip of the handheld welding tool in use.

In another embodiment, the elongate body further includes a flange defining a narrowed throat opening, the flange acting as a stop for the handle region of the handheld welding tool inserted into the tool handle shell.

In another embodiment, the elongate body further includes a plurality of surfaces extending from an inner wall of elongate body, the surfaces adapted to receive a correspondingly shaped feature of the handle region of the handheld welding tool, such that the handheld tool is held in position within the elongate body.

In another embodiment, the elongate body further includes a flange defining a narrowed throat opening in the neck portion of the elongate body, and a plurality of surfaces extending from an inner wall of elongate body below the flange, whereby the flange acts as a stop for a handle region of the handheld welding tool inserted into the tool handle shell, and the surfaces extending from an inner wall of elongate body are adapted to receive a correspondingly shaped feature of the handle region of the handheld welding tool, such that the handle region of the handheld welding tool is securely held in position within the elongate body.

In another aspect, there is provided a tool head shell for a handheld welding tool, comprising: a face portion defining an opening for accommodating an arc welding electrode holder of the handheld welding tool extending therethrough; a base portion defining an opening for receiving a neck portion of the arc welding electrode holder tool extending therethrough; wherein the tool head shell comprises a material that is resiliently flexible in cold weather, is heat resistant, and absorbs substantial impacts without breakage.

In an embodiment, the resiliently flexible material is a low hardness thermoplastic elastomer, silicon, or polyurethane.

In another embodiment, the thermoplastic elastomer is polypropylene based to be resistance to high temperature and remain flexible and resilient in cold weather.

While the above description provides examples of one or more embodiment, it will be appreciated that other embodiments may be within the scope of the present description as interpreted by one of skill in the art.

What is claimed is:

1. A tool handle shell, comprising:
a generally elongate body adapted to receive a handle region of a handheld tool, the elongate body having a neck portion, an enlarged shoulder portion, and a handle portion;
whereby the enlarged shoulder portion acts to provide a grasping point such that holding the handheld tool is more comfortable to hold for longer periods of time.

2. The tool handle shell of claim 1, wherein the elongate body comprises a material that is resilient in cold weather, is heat resistant, and absorbs substantial impacts without breakage.

3. The tool handle shell of claim 1, wherein the elongate body comprises a glass reinforced nylon or glass reinforced polyurethane material.

4. The tool handle shell of claim 1, wherein the handle portion includes a plurality of protuberances on its surface for providing a better grip of the handheld tool in use.

5. The tool handle shell of claim 1, wherein the elongate body further includes a flange defining a narrowed throat opening, the flange acting as a stop for the handle region of the handheld tool inserted into the tool handle shell.

6. The tool handle shell of claim 5, wherein the elongate body further includes a plurality of surfaces extending from an inner wall of elongate body, the surfaces adapted to receive a correspondingly shaped feature of the handle region of the handheld tool, such that the handheld tool is held in position within the elongate body.

7. The tool handle shell of claim 1, wherein the elongate body further includes a flange defining a narrowed throat opening in the neck portion of the elongate body, and a plurality of surfaces extending from an inner wall of elongate body below the flange, whereby the flange acts as a stop for the handle region of the handheld tool inserted into the tool handle shell, and the surfaces extending from an inner wall of elongate body are adapted to receive a correspondingly shaped feature of the handle region of the handheld tool, such that the handle region of the handheld tool is securely held in position within the elongate body.

8. The tool handle shell of claim 1, wherein the handheld tool is a handheld welding tool, and the elongate body is adapted to receive a handle region of the handheld welding tool.

9. A tool handle shell for a handheld welding tool, comprising:
a generally elongate body adapted to receive a handle region of the handheld welding tool, the elongate body having a neck portion, an enlarged shoulder portion, and a handle portion;
wherein the elongate body comprises a material that is resilient in cold weather, is heat resistant, and absorbs substantial impacts without breakage.

10. The tool handle shell of claim 9, wherein the elongate body comprises a glass reinforced nylon or glass reinforced polyurethane material.

11. The tool handle shell of claim 9, wherein the handle portion includes a plurality of protuberances on its surface for providing a better grip of the handheld welding tool in use.

12. The tool handle shell of claim 9, wherein the elongate body further includes a flange defining a narrowed throat opening, the flange acting as a stop for the handle region of the handheld welding tool inserted into the tool handle shell.

13. The tool handle shell of claim 9, wherein the elongate body further includes a plurality of surfaces extending from an inner wall of elongate body, the surfaces adapted to receive a correspondingly shaped feature of the handle region of the handheld welding tool, such that the handheld tool is held in position within the elongate body.

14. The tool handle shell of claim 9, wherein the elongate body further includes a flange defining a narrowed throat opening in the neck portion of the elongate body, and a plurality of surfaces extending from an inner wall of elongate body below the flange, whereby the flange acts as a stop for a handle region of the handheld welding tool inserted into the tool handle shell, and the surfaces extending from an inner wall of elongate body are adapted to receive a correspondingly shaped feature of the handle region of the handheld welding tool, such that the handle region of the handheld welding tool is securely held in position within the elongate body.

15. A tool head shell for a handheld welding tool, comprising:
a face portion defining an opening for accommodating an arc welding electrode holder of the handheld welding tool extending therethrough;
a base portion defining an opening for receiving a neck portion of the arc welding electrode holder tool extending therethrough;
wherein the tool head shell comprises a material that is resiliently flexible in cold weather, is heat resistant, and absorbs substantial impacts without breakage.

16. The tool head shell of claim 15, wherein the resiliently flexible material is one of a low hardness thermoplastic elastomer, silicon, or polyurethane.

17. The tool head shell of claim 15, wherein thermoplastic elastomer is polypropylene based to be resistance to high temperature and remain flexible and resilient in cold weather.
